(19) United States
(12) Patent Application Publication
(10) Pub. No.: US 2020/0113130 A1
(43) Pub. Date: Apr. 16, 2020

(54) PRECISION FERTILIZER SYSTEM

(71) Applicant: Paul K. Anderson, Byron, WY (US)

(72) Inventor: Paul K. Anderson, Byron, WY (US)

(21) Appl. No.: 16/599,996

(22) Filed: Oct. 11, 2019

Related U.S. Application Data
(60) Provisional application No. 62/744,387, filed on Oct. 11, 2018.

(51) Int. Cl. A01C 23/04

(52) U.S. Cl. CPC A01C 23/047

(57) ABSTRACT

A precision fertilizer system used with a sprinkler system having a water conduit with a plurality of nozzles positioned along a length of the water conduit. A fertilizer delivery conduit is connected to a tank and runs along the length of the water conduit. A plurality of valves are connected to the fertilizer delivery conduit adjacent the nozzles.

### CROSS REFERENCE TO RELATED APPLICATION

This application claims the benefit of the priority of U.S. Provisional Application No. 62/744,387 filed on Oct. 11, 2018, the contents of these applications are hereby incorporated by reference in their entirety.

### BACKGROUND OF THE INVENTION

The present invention is directed to a system for applying fertilizer in a more accurate and precise manner, and more particularly, a system that is used in conjunction with conventional sprinkler systems.

Precision in farming activities have become more prevalent in recent years where seed can be placed within a fraction of an inch and through GPS and thermo imagery as the seed grows from the time the crop emerges to harvest. Precision application through ground sprayers and direct injection are known and use computer programs to manage the application of fertilizer. Precision application of fertilizer, such as nitrogen, is particularly important, as this is one of the largest cost inputs in the production process. While existing systems are useful, they are expensive, complex, and not as accurate as desired, leading to waste. Thus, there is a need in the art for an application system that addresses these deficiencies.

An objective of the present invention is to provide a precision fertilizer system that reduces waste.

Another objective of the present invention is to provide a precision fertilizer system that is more accurate in applying fertilizer

These and other objectives will be apparent to those having ordinary skill in the art based upon the following written description, drawings, and claims.

### SUMMARY OF THE INVENTION

A precision fertilizer system is used with a sprinkler system having a water conduit and a plurality of nozzles connected to the water conduit. Attached to, and running along the length of the water conduit, is a fertilizer delivery conduit.

The fertilizer delivery conduit is connected to and in communication with a tank that contains fertilizer. Also, a plurality of flow adjusting valves are connected to the fertilizer delivery conduit.

The flow adjusting valves are connected to a control system. Using software, the control system determines a desired amount of fertilizer needed for a specific location using environmental and geographic data. Once determined, the control system activates the flow adjusting valves to release the desired amount of fertilizer.

### BRIEF DESCRIPTION OF THE DRAWINGS

FIG. 1 is a perspective view of a precision fertilizer system; and

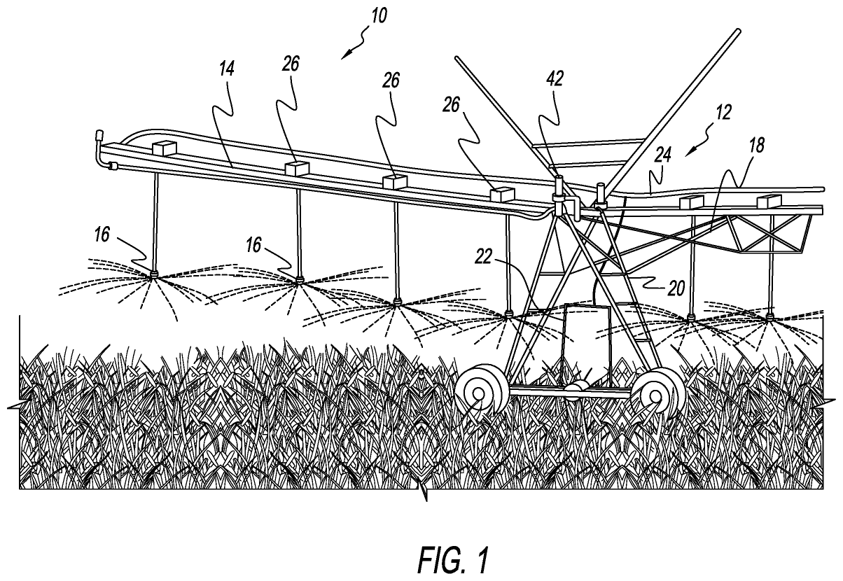

FIG. 2 is a schematic view of a precision fertilizer system.

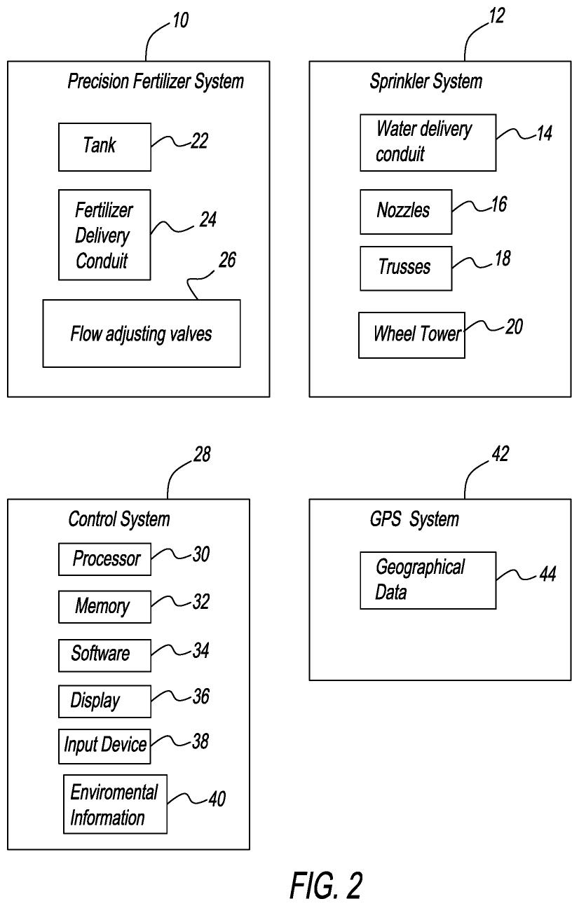

### DETAILED DESCRIPTION OF THE PREFERRED EMBODIMENTS

A precision fertilizer system 10 is used in relation with a conventional sprinkler system 12. In one example, the sprinkler system 12 is a center pivot sprinkler having a water delivery conduit 14 having a plurality of sprinklers or nozzles 16 spaced along the length of conduit 14. The conduit 14 is connected to and supported by trusses 18 which are mounted to wheel towers 20. Typically, the center pivot sprinkler system 12 is powered by an electric motor (not shown).

The precision fertilizer system 10 includes a tank 22, preferably located at the base of the sprinkler system 12. The tank 22 is connected to, and in communication with, a fertilizer delivery conduit 24. The fertilizer delivery conduit 24 is attached to and runs along the length of the water delivery conduit 14. Positioned adjacent the nozzles 16 are flow adjusting valves 26 that are connected to the fertilizer delivery conduit 24. Each flow adjusting valve 26 has a GPS locator and is of any size, shape, or structure. As an example, the flow adjusting valve 26 is electric using 220v to 480v, operated with a solar powered blue tooth system having a back-up battery, or the like.

The flow adjusting valves 26 are connected to a control system 28 that includes a processor 30, memory 32, software 34, display 36, and an input device 38. Stored within the memory 32 is environmental information or data 40 such as soil maps, rain fall, temperature, humidity, topography, organic matter, evaporator transpiration, seed type, seed maturity, current levels of nitrogen, phosphorus, and the like. The environmental information is either input, provided by sensors, or downloaded from third party sources and contains present and past data. The control system 28 is also connected to GPS 42 that is mounted to the sprinkler system 12.

In operation, based upon the stored environmental information 40 and geographical data 44 provided from the GPS 42, the processor 30, using the software 34, determines a desired amount of fertilizer to be provided to a specific geographic location (within one square foot). Based upon this determination, the control system 28 sends a signal to each flow adjusting valve 26 activating each valve 26 to permit flow of the determined desired amount of fertilizer to be provided to the specific geographic location. As fertilizer is released from the valve 26, the fertilizer is combined with water released from the adjacent nozzle 16, which acts as a carrier for the fertilizer to the soil.

From the above discussion and accompanying figures and claims it will be appreciated that a precision fertilizer system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A precision fertilizer system comprising:
a sprinkler system having a water conduit and a plurality of nozzles spaced along a length of the water conduit;
a fertilizer delivery conduit connected to and in communication with a tank and attached to and runs along the length of the water conduit;
a flow adjusting valve position adjacent each of the plurality of nozzles; and
a control system connected to the flow adjusting valves.

2. The system of claim 1 wherein each flow adjusting valve has a GPS locator.

3. The system of claim 1 wherein the control system determines an amount of fertilizer to be provided to a specific location.

4. The system of claim 3 wherein the control system determines the amount of fertilizer based upon environmental data and geographic data.

5. The system of claim 3 wherein based upon the determination of the amount of fertilizer, the control system sends an activation signal to the flow adjusting valves.

6. The system of claim 5 wherein fertilizer is released through the flow adjustment valves upon activation and is combined with water released from an adjacent nozzle.
